(19) United States
(12) Patent Application Publication
(10) Pub. No.: US 2015/0042625 A1
(43) Pub. Date: Feb. 12, 2015

(54) DISPLAY CONTROL SYSTEM AND DISPLAY DEVICES

(71) Applicant: PANASONIC CORPORATION, Osaka (JP)

(72) Inventors: Kazuhiro YAMADA, Osaka (JP); Yasuhiro TANAKA, Hyogo (JP); Masahiro ISHII, Hyogo (JP); Takeshi TANAKA, Hyogo (JP)

(21) Appl. No.: 14/523,635

(22) Filed: Oct. 24, 2014

Related U.S. Application Data
(63) Continuation of application No. PCT/JP2013/002671, filed on Apr. 19, 2013.

(30) Foreign Application Priority Data
Apr. 26, 2012 (JP) 2012-101666

(51) Int. Cl. G06F 3/03; G06F 3/038; G06F 3/0354

(52) U.S. Cl. CPC G06F 3/0321; G06F 3/03542; G06F 3/0386
USPC 345/179

(57) ABSTRACT

A display control system includes a display device including a display area in which a plurality of pixels is provided and which displays an image, and a pointing device configured to indicate one of positions on the display area. Position information patterns that represent the positions on the display area are provided in the display area. The pointing device is configured to optically read one of the position information patterns corresponding to the one of the positions. Each of the position information patterns is formed by a group of a plurality of marks. The half or more of the marks are provided in the sub pixels of a specific color of a plurality of different colors.

### CROSS-REFERENCE TO RELATED APPLICATIONS

This is a continuation of International Application No. PCT/JP2013/002671 filed on Apr. 19, 2013, which claims priority to Japanese Patent Application No. 2012-101666 filed on Apr. 26, 2012. The entire disclosures of these applications are incorporated by reference herein.

### BACKGROUND

The present disclosure relates to a display control system enabling input of instruction to a display area of a displace device using a pointing device, and the display device.

Conventionally, a technique in which, when characters, etc. are written on a piece of paper with a pen, the information written on the paper is computerized and the computerized information is sent to a server and/or a terminal has been known.

### SUMMARY

In recent years, systems enabling handwriting input in which a display surface of a display device is caused to display the trace of a writing material as it is by writing a character, etc. on the display surface using the writing material, such as a stylus, etc., have been developed. However, such systems are still works in progress. Specifically, for high-definition handwriting input, there is still room for further development.

The following display control systems is conceivable: a display control system which includes a display device including a display area configured to display an image and a pointing device configured to indicate one of positions on the display area and performs display control in accordance with the position indicated by the pointing device, and in which position information patterns that represent the positions on the display area are provided on the display area, the pointing device reads one of the position information patterns corresponding to the indicated position, and thereby, the display device performs display of a trace, etc.

In the above-described configuration, the following problem is expected to arise. That is, the display area is an area provided in order to display an image, and therefore, when the position information pattern is provided on the display area, unevenness in a display image on the display area might be caused.

The technique disclosed herein may allow reduction in unevenness in the display area.

The technique disclosed herein is subjected to a display control system which includes a display device including a display area in which a plurality of pixels is provided and which displays an image, and a pointing device configured to indicate one of positions on the display area, and the display control system performs display control in accordance with the one of the positions indicated by the pointing device. Position information patterns that represent the positions on the display area are provided in the display area, the pointing device is configured to optically read one of the position information patterns corresponding to the one of positions, each of the pixels includes sub pixels of a plurality of different colors, each of the position information patterns is formed by a group of a plurality of marks, and the half or more of the marks are provided in the sub pixels of a specific color of the plurality of different colors.

The technique disclosed herein is subjected to a display device including a display area in which a plurality of pixels is provided and which displays an image. Position information patterns that are configured to be optically read from outside and represent the positions on the display area are provided in the display area, each of the pixels includes sub pixels of a plurality of different colors, each of the position information patterns is formed by a group of a plurality of marks, and the half or more of the marks are provided in the sub pixels of a specific color of the plurality of different colors.

With the above-described display control system, unevenness in the display area may be reduced.

With the display device, unevenness in the display area may be reduced.

### BRIEF DESCRIPTION OF THE DRAWINGS

FIG. 1 is a schematic view of a display control system according to a first embodiment.

FIG. 2 is a block diagram of the display control system.

FIG. 3 is a schematic cross-sectional view of a display panel.

FIG. 4 is an enlarged view of a display area.

FIG. 5 is a schematic cross-sectional view of a digital pen.

FIG. 6 is a plan view of a color filter.

FIG. 7A is a view illustrating the position pattern of a dot corresponding to the numerical reference “1,” FIG. 7B is a view illustrating the position pattern of a dot corresponding to the numerical reference “2,” FIG. 7C is a view illustrating the position pattern of a dot corresponding to the numerical reference “3,” and FIG. 7D is a view illustrating the position pattern of a dot corresponding to the numerical reference “4.”

FIG. 8 is a flow chart illustrating a flow of processing of the display control system.

FIG. 9 is a plan view of a color filter according to a modified example.

FIG. 10A is a view illustrating the position pattern of a dot corresponding to the numerical reference “1,” FIG. 10B is a view illustrating the position pattern of a dot corresponding to the numerical reference “2,” FIG. 10C is a view illustrating the position pattern of a dot corresponding to the numerical reference “3,” and FIG. 10D is a view illustrating the position pattern of a dot corresponding to the numerical reference “4.”

FIG. 11 is a plan view of a color filter according to another modified example.

FIG. 12 is a plan view of a color filter according to a second embodiment.

FIG. 13A is a view illustrating the position pattern of a dot corresponding to the numerical reference “1,” FIG. 13B is a view illustrating the position pattern of a dot corresponding to the numerical reference “2,” FIG. 13C is a view illustrating the position pattern of a dot corresponding to the numerical reference “3,” and FIG. 13D is a view illustrating the position pattern of a dot corresponding to the numerical reference “4.”

FIG. 14A is a view illustrating the position pattern of a dot corresponding to the numerical reference “1” according to a modified example, FIG. 14B is a view illustrating the position pattern of a dot corresponding to the numerical reference “2” according to the modified example, FIG. 14C is a view illustrating the position pattern of a dot corresponding to the numerical reference “3” according to the modified example, and FIG. 14D is a view illustrating the position pattern of a dot corresponding to the numerical reference “4” according to the modified example.

FIG. 15 is a schematic view of a digital pen according to another embodiment.

FIG. 16 is a block diagram of a display control system according to another embodiment.

FIG. 17 is a flow chart illustrating a flow of the display control system.

### DETAILED DESCRIPTION

Embodiments will be described below in detail with reference to the accompanying drawings as appropriate. However, detailed description more than necessary may be omitted. For example, the detail description of well-known matters and the redundant description of substantially the same configurations may be omitted. Such omission is made to avoid unnecessary redundancy in the following description and to help those skilled in the art easily understand the present disclosure.

Note that the present inventor(s) provides the attached drawings and the following description for those skilled in the art to fully understand the present disclosure and does not intend to limit the subject described in the claims by the attached drawings and the following description.

### First Embodiment

### 1. Outline of Display Control System

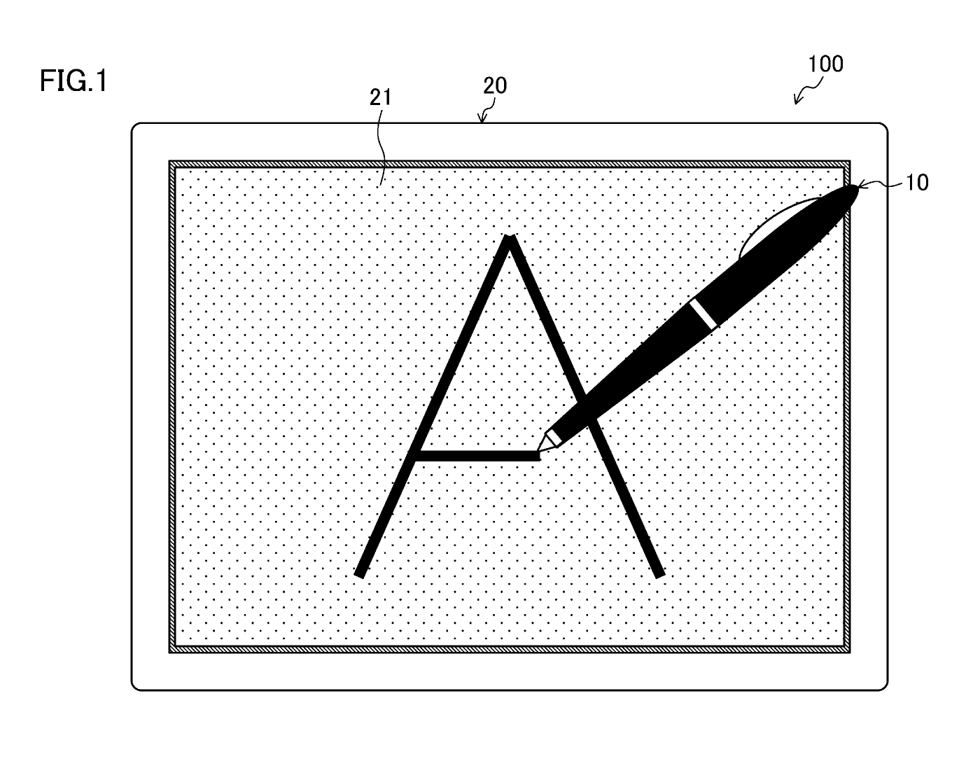

FIG. 1 is a view schematically illustrating an external appearance of a display control system 100 according to a first embodiment. The display control system 100 includes an optical digital pen (which will be hereinafter merely referred to as a “digital pen”) 10 and a display device 20. As will be described later in detail, the display device 20 is a liquid crystal display and displays various images on a display area 21. Dot patterns each representing a corresponding one of positions on the display area 21 are provided to the display device 20. The digital pen 10 optically reads one of the dot patterns to detect information (which will be hereinafter also referred to as “position information”) relating to the position of the digital pen 10 on the display area 21 and transmits the position information to the display device 20. The display device 20 receives the position information as an input and performs various display controls. For example, the display device 20 continuously displays dots on the display area 21 in accordance with a trace of the digital pen 10. Thus, characters and figures, etc. can be handwritten on the display area 21 using the digital pen 10. Also, the display device 20 continuously erases dots on the display area 21 in accordance with a trace of the digital pen 10. Thus, characters and figures, etc. on the display area 21 can be erased using the digital pen 10 as an eraser. That is, the digital pen 10 functions as a readout device and also functions as an input device to the display control system 100. The digital pen 10 is an example of a pointing device.

### 2. Configuration of Display Device

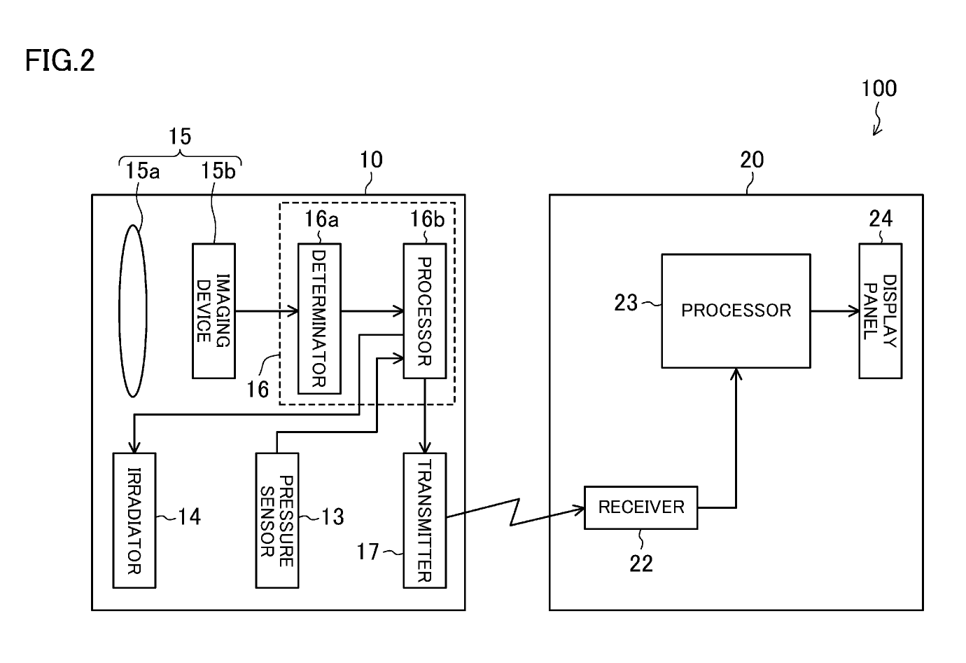

The display device 20 will be described below. FIG. 2 is a block diagram schematically illustrating a configuration of the display control system 100.

The display device 20 includes a receiver 22 configured to receive an external signal, a display processor 23 configured to control the entire display device 20, and a display panel 24 configured to display an image.

The receiver 22 receives a signal transmitted from the digital pen 10, which will be described later in detail. The signal received by the receiver 22 is transmitted to the display processor 23.

The display processor 23 includes a CPU and a memory, etc., and, a program used for operating a CPU is provided therein. For example, the display processor 23 controls the display panel 24, based on a signal transmitted from the digital pen 10, to change contents that the display processor 23 causes the display panel 24 to display.

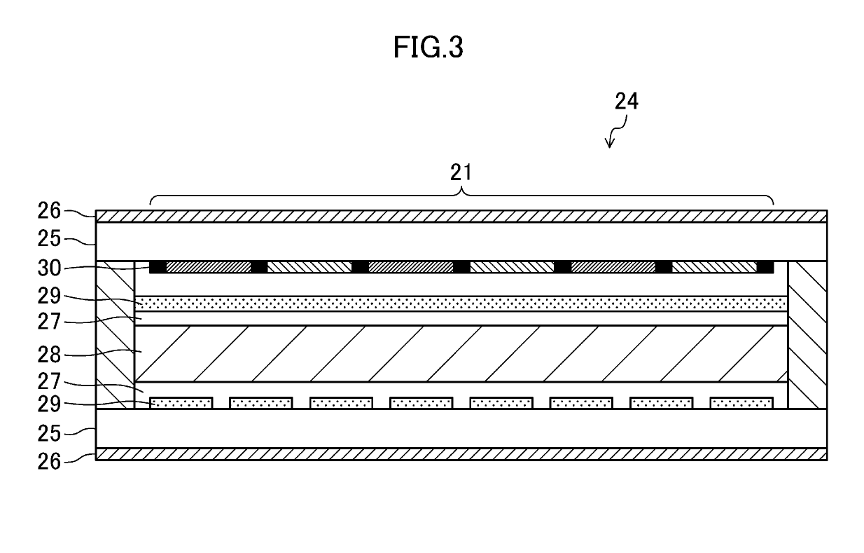

FIG. 3 is a schematic cross-sectional view of the display panel 24. The display panel 24 is a liquid crystal panel. A basic configuration of the display panel 24 is similar to a configuration of a typical liquid crystal panel. Specifically, the display panel 24 includes a pair of glass substrates 25, a polarizing filter 26 provided on an external surface of each of the glass substrates 25, a pair of oriented films 27 provided between the pair of glass substrates 25, a liquid crystal layer 28 provided between the pair of oriented films 27, a transparent electrode 29 provided on each of the oriented films 27, and a color filter 30 provided between the glass substrate 25 located closer to a surface of the display panel 24 and the transparent electrode 29. The display area 21 is formed on the surface of the display panel 24.

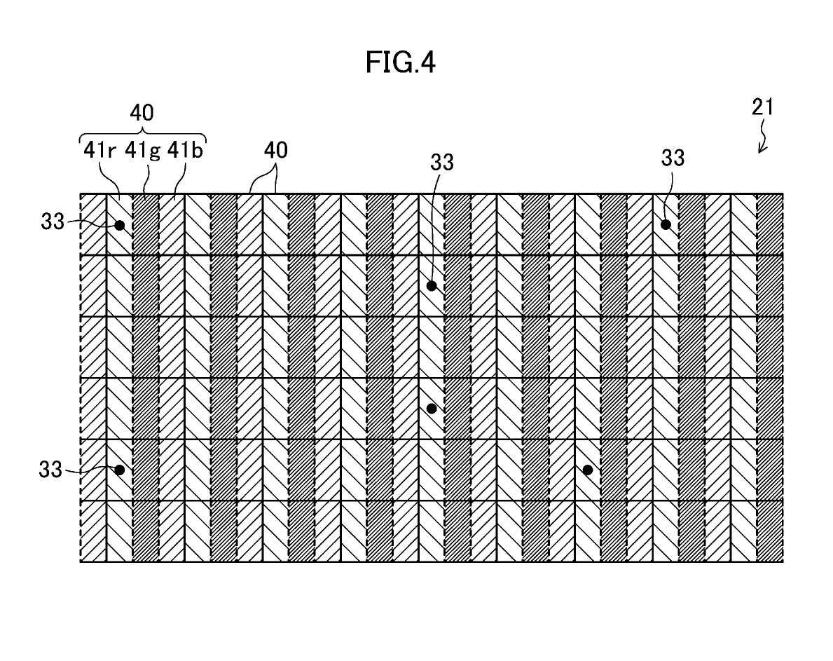

FIG. 4 is an enlarged view of the display area 21. A plurality of pixels 40 is provided in the display area 21. The plurality of pixels 40 is provided in matrix in the display area 21. Each of the pixels 40 includes a red sub pixel 41r, a green sub pixel 41g, and a blue sub pixel 41b. Note that, when the colors of the pixels are not distinguished, the term “sub pixel(s) 41” is simply used. Various images are displayed in the display area 21. As will be described later in detail, dots 33 are provided in the sub pixels 41. A group of the dots 33 forms a dot pattern. The dot pattern is an example of a position information pattern. The dots 33 are an example of marks.

### 3. Configuration of Digital Pen

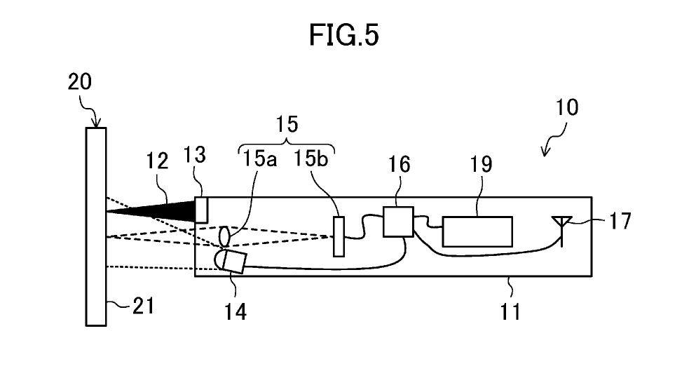

Next, a detail configuration of the digital pen 10 will be described. FIG. 5 is a cross-sectional view illustrating a schematic configuration of the digital pen 10.

The digital pen 10 includes a cylindrical body 11, a nib 12 attached to the tip of the body 11, a pressure sensor 13 configured to detect pressure applied to the nib 12, an optical source 14 configured to emit infrared light, a reader 15 configured to read incident infrared light, a controller 16 configured to control the digital pen 10, a transmitter 17 configured to output a signal to the outside, and a power supply 19 configured to supply electric power to each member of the digital pen 10.

The body 11 is made of a cylinder similar to a typical pen. The nib 12 has a tapered shape, and the tip of the nib 12 is rounded so that the surface of the display area 21 is not scratched. The nib 12 preferably has such a shape that a user easily recognizes an image displayed on the display area 21.

The pressure sensor 13 is built in the body 11, and is connected to a base end portion of the nib 12. The pressure sensor 13 detects pressure applied to the nib 12 and transmits the result of the detection to the controller 16. Specifically, the pressure sensor 13 detects pressure applied to the nib 12 when a user writes a character, etc. on the display area 21 using the digital pen 10. That is, the pressure sensor 13 is used to determine whether or not a user has intension to input a character, etc. using the digital pen 10.

The optical source 14 is provided at a tip portion of the body 11 near the nib 12. The optical source 14 includes, for example, an infrared LED, and is configured to emit infrared light from the tip of the body 11.

The reader 15 is provided at the tip portion of the body 11 near the nib 12. The reader 15 includes an objective lens 15a and an imaging device 15b. The objective lens 15a forms an image on the imaging device 15b from incident light. Since the objective lens 15a is provided at the tip portion of the body 11, infrared light emitted from the optical source 14 and reflected on the display device 20 enters the objective lens 15a. The imaging device 15b is provided on the optical axis of the objective lens 15a. The imaging device 15b converts an optical image formed on its imaging plane to an electrical signal and outputs the electrical signal to the controller 16. The imaging device 15b includes, for example, a CCD image sensor or a CMOS image sensor. As described in detail later, the dot patterns are made of a material that absorbs infrared light, and thus, infrared light is not reflected at the dot patterns. As a result, an optical image in which the dot patterns appear black is captured by the imaging device 15b.

As illustrated in FIG. 2, the controller 16 includes a decoder 16a and a pen processor 16b. The decoder 16a determines the position information of the digital pen 10 on the display area 21, based on an image signal transmitted from the reader 15. Specifically, the decoder 16a obtains a dot pattern from the image signal obtained by the reader 15 and identifies, based on the dot pattern, the position of the nib 12 on the display area 21. Information about the position of the nib 12 determined by the decoder 16a is sent to the pen processor 16b. The pen processor 16b controls the entire digital pen 10. The pen processor 16b includes a CPU and a memory, etc., and a program used for operating the CPU is also provided therein.

The transmitter 17 transmits a signal to the outside. Specifically, the transmitter 17 wirelessly transmits the position information determined by the decoder 16a to the outside. The transmitter 17 performs near field wireless communication with the receiver 22 of the display device 20. The transmitter 17 is provided at an end portion of the body 11, which is opposite to the nib 12.

### 4. Detailed Configuration of Color Filter

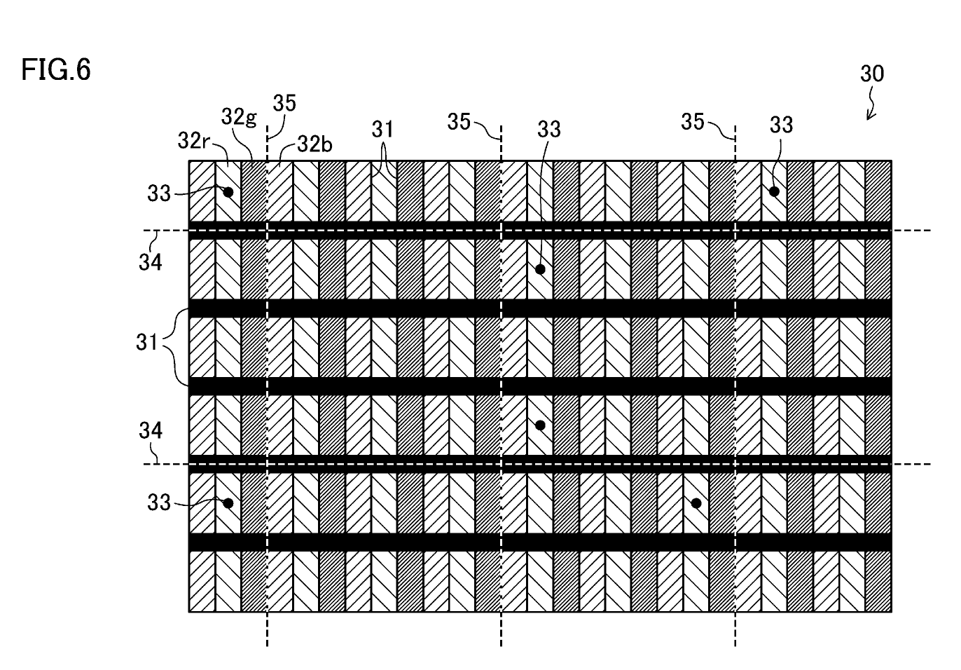

Subsequently, the detailed configuration of the color filter 30 will be described. FIG. 6 is a plan view of the color filter 30.

The color filter 30 includes a black matrix 31, pixel regions 32 which are defined by the black matrix 31 and are transmissive to light in certain colors, and dots 33 provided in the pixel regions 32. Each of the pixel regions 32 has a rectangular shape. The pixel regions 32 include a red pixel region 32r transmissive to red (R) light, a green pixel region 32g transmissive to green (G) light, and a blue pixel region 32b transmissive to blue (B) light. The pixel regions 32 correspond to the sub pixels 41 of the display area 21. Specifically, the red pixel region 32r corresponds to the red sub pixel 41r, the green pixel region 32g corresponds to the green sub pixel 41g, and the blue pixel region 32b corresponds to the blue sub pixel 41b. Note that, when the colors of light to be transmitted are not distinguished from one another, the term “pixel region(s) 32” is simply used. The red pixel region 32r, the green pixel region 32g, and the blue pixel region 32b are located in this order in the lateral direction of the pixel region 32. In the longitudinal direction of the pixel region 32, the pixel regions 32 of the same color are located. That is, next to one red pixel region 32r in the longitudinal direction, another red pixel region 32r is located. Similarly, next to one green pixel region 32g in the longitudinal direction, another green pixel region 32g is located. Similar applies to the blue pixel region 32b. The black matrix 31 includes column lines extending in the longitudinal direction of the pixel region 32 and row lines extending in the lateral direction of the pixel region 32, and is formed in a lattice shape. The row lines are larger in width than the column lines. The black matrix 31 and the dots 33 are made of a material containing carbon black as a main component. The dots 33 are formed into a solid circular shape. The dots 33 are provided not in all of the pixel regions 32 but in some of the pixel regions 32. In the color filter 30, a group of the dots 33 forms a dot pattern. Dot patterns differ from one another depending on positions in the color filter 30.

The dot patterns will be described in detail below.

First, first reference lines 34 and second reference lines 35 are defined on color filter 30. These first and second reference lines 34 and 35 are virtual lines, that is, do not exist in reality. The first reference lines 34 are straight lines extending in the lateral direction of the pixel regions 32 and each of the first reference lines 34 extends on the corresponding one of the row lines of the black matrix 31. The first reference lines 34 are arranged in the longitudinal direction of the pixel regions 32 on every three row lines of the black matrix 31. The second reference lines 35 are straight lines extending in the longitudinal direction of the pixel regions 32 and each of the second reference lines 35 extends on the corresponding one of the column lines of the black matrix 31 each of which separates the corresponding one of the green pixel regions 32g and the corresponding one of the blue pixel regions 32b from each other. The second reference lines 35 are arranged in the lateral direction of the pixel regions 32. The second reference lines 35 are provided not on all of the column lines of the black matrix 31 each of which separates the corresponding one of the green pixel regions 32g and the corresponding one of the blue pixel regions 32b from one another but at every three groups of the green pixel region 32g and the blue pixel region 32b. The first reference lines 34 and the second reference lines 35 define the lattice on the color filter 30.

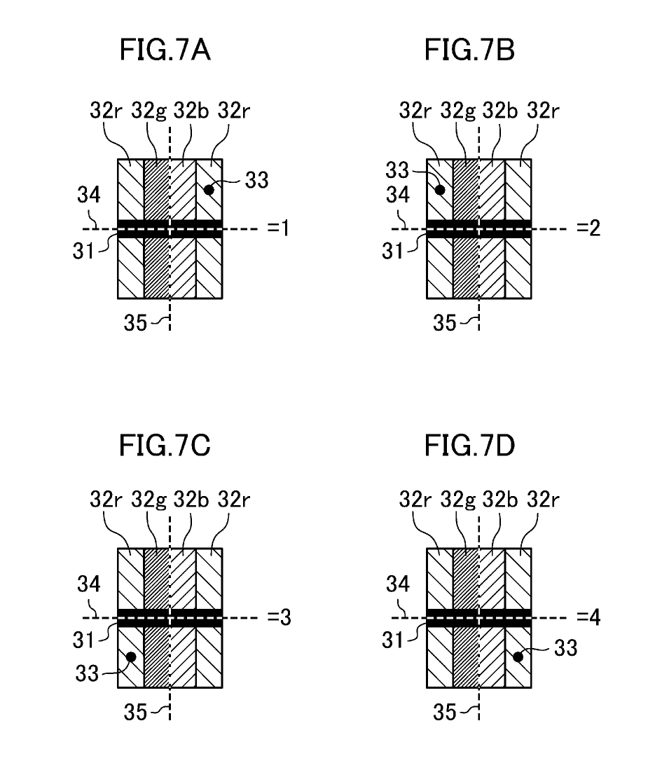

Each of the dots 33 is located near the intersection point of the corresponding one of the first reference lines 34 and the corresponding one of the second reference lines 35. FIGS. 7A-7D are views illustrating position patterns of the dots 33. The dot 33 is a shifted from the intersection point in any one of four oblique directions relative to the corresponding first and second reference lines 34 and 35. Specifically, the position of the dot 33 is any of the positions illustrated in FIGS. 7A-7D. In the position of FIG. 7A, the dot 33 is located in the red pixel region 32r at the upper right of the intersection point of the first reference line 34 and the second reference line 35. The digitized representation of this position is “1.” In the position of FIG. 7B, the dot 33 is located in the red pixel region 32r at the upper left of the intersection point of the first reference line 34 and the second reference line 35. The digitized representation of this position is “2.” In the position of FIG. 7C, the dot 33 is located in the red pixel region 32r at the lower left of the intersection point of the first reference line 34 and the second reference line 35. The digitized representation of this position is “3.” In the position of FIG. 7D, the dot 33 is located in the red pixel region 32r at the lower right of the intersection point of the first reference line 34 and the second reference line 35. The digitized representation of this position is “4.” In any one of the positions, the dot 33 is located in the red pixel region 32r, i.e., in the red sub pixel 41r.

One unit area includes 6×6 dots, and 36 dots 33 included in one unit area form one dot pattern. The position of each of 36 dots 33 included in each unit area is arranged in any one of the positions of “1”-“4” described above, so that a large number of dot patterns can be formed. Each unit area has a different dot pattern.

Information is added to each of the dot patterns. Specifically, each of the dot patterns is a coding pattern which codes position information. For example, the position information is a position coordinate for a corresponding unit area. That is, when the color filter 30 is divided into unit areas each including 6×6 dots, each of the dot patterns represents the position coordinate of the corresponding one of unit areas. As a method for such patterning (coding) of the dot patterns and performing coordinate transformation (decoding), for example, a known method as disclosed in Japanese Patent Publication No. 2006-141067 may be used.

### 5. Operation

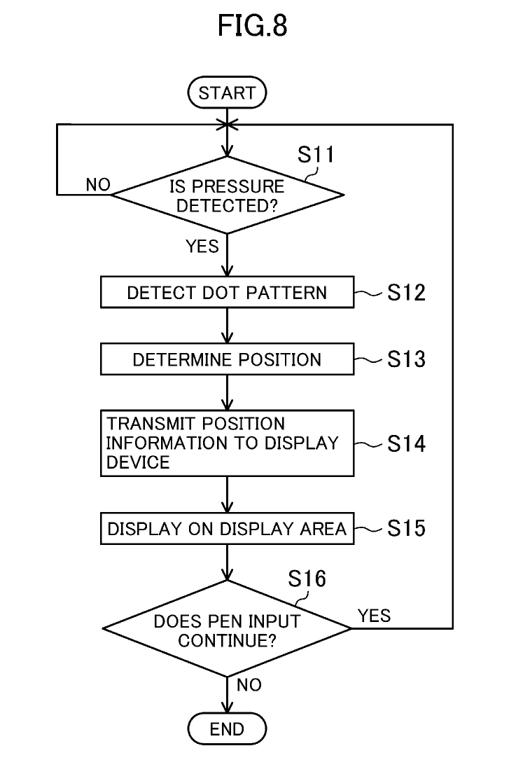

The operation of the display control system 100 configured as described above will be described. FIG. 8 is a flow chart illustrating a flow of processing performed by the display control system 100. An example where a user inputs a character to the display device 20 with the digital pen 10 will be described below.

First, when a power supply of the display control system 100 is turned on, in Step S11, the pen processor 16b of the digital pen 10 starts monitoring of pressure applied to the nib 12. The detection of the pressure is performed by the pressure sensor 13. When the pressure is detected (YES), the pen processor 16b determines that the user inputs a character to the display area 21 of the display device 20, and the process proceeds to Step S12. While the pressure is not detected (NO), the pen processor 16b repeats Step S11.

In Step S12, the reader 15 of the digital pen 10 detects a dot pattern formed in the display area 21. When the pressure is detected by the pressure sensor 13, the optical source 14 emits infrared light. Note that the irradiation section 14 may start emitting infrared light when the power supply of the digital pen 10 is turned on. A part of the infrared light is absorbed at least into the dots 33 provided in the color filter 30 of the display device 20, whereas the rest of the infrared light is reflected at the pixel regions 32, etc. The reflected infrared light enters the imaging device 15b via the objective lens 15a. The objective lens 15a is located so as to receive reflected light from a position indicated by the nib 12 on the display area 21. As a result, the dot pattern in the indicated position on the display area 21 is captured by the imaging device 15b. In this way, the reader 15 optically reads the dot pattern. The image signal obtained by the reader 15 is transmitted to the decoder 16a.

In Step S13, the decoder 16a obtains the dot pattern from the image signal and, based on the dot pattern, the decoder 16a determines the position of the nib 12 on the display area 21. Specifically, the decoder 16a performs predetermined image processing on the obtained image signal, thereby obtaining the dot pattern. For example, similar to the dots 33, the black matrix 31 is made of carbon black, and thus, absorbs the infrared light. Therefore, an image from the reader 15 includes the black matrix 31 in the same state as the state of the dots 33. Then, the decoder 16a performs predetermined image processing on the obtained image signal from the reader 15 to make it easier to determine the dots 33 from the black matrix 31, thereby obtaining the position of the dots 33, based on the processed image signal. Subsequently, the decoder 16a determines a unit area including 6×6 dots, based on the obtained position of the dots 33, and determines the position coordinate (position information) of the unit area, based on the dot pattern of the unit area. The decoder 16a converts the dot pattern to a position coordinate by predetermined operation corresponding to the coding method of the dot pattern. The determined position information is transmitted to the pen processor 16b.

Subsequently, in Step S14, the pen processor 16b transmits the position information to the display device 20 via the transmitter 17.

The position information transmitted from the digital pen 10 is received by the receiver 22 of the display device 20. The received position information is transmitted from the receiver 22 to the display processor 23. In Step S15, upon receiving the position information, the display processor 23 controls the display panel 24 so that display contents in a position corresponding to the position information are changed. In the example, since a character is input, a point is displayed in the position corresponding to the position information on the display area 21.

Subsequently, in Step S16, the pen processor 16b determines whether or not the input by the user continues. When the pressure sensor 13 detects the pressure, the pen processor 16b determines that the input by the user continues, and the process goes back to Step S11. The above-described flow is repeated, so that points are, in accordance with the movement of the nib 12 of the digital pen 10, continuously displayed in the positions of the nib 12 on the display area 21. Finally, a character in accordance with the trace of the nib 12 of the digital pen 10 is displayed on the display surface 21 of the display device 20.

On the other hand, in Step S16, when the pressure sensor 13 detects no pressure, the pen processor 16b determines that the input by the user does not continue, and the process is terminated.

In this way, the display device 20 displays, on the display area 21, the trace of the tip of the digital pen 10 on the display area 21, thereby enabling handwriting input to the display area 21 using the digital pen 10.

Note that, although the case of inputting a character has been described above, the use of the display control system 100 is not limited to the case described above. In addition to characters, digits, symbols, and drawings, etc. can be, of course, input, and it is also possible to use the digital pen 10 as an eraser to erase characters, and drawings, etc. displayed in the display area 21. That is, the display device 20 continuously erases displays in the positions of the digital pen 10 on the display area 21 in accordance with the movement of the digital pen 10, thereby erasing displays in parts corresponding to the trace of the tip of the digital pen 10 on the display area 21. Furthermore, the digital pen 10 may be used as a mouse to move a cursor displayed on the display area 21 or to select an icon displayed on the display area 21. That is, a graphical user interface can be operated using the digital pen 10. As described above, in the display control system 100, the position on the display area 21 indicated by the digital pen 10 is input to the display device 20, and the display device 20 performs various display controls in accordance with the input.

### 6. Advantages of Embodiment

As described above, according to the present embodiment, the display control system 100 includes the display device 20 having the display area 21 in which the plurality of pixels 40 is provided and which displays an image, and the digital pen 10 configured to indicate one of positions on the display area 21, and performs display control in accordance with the one of the positions indicated by the digital pen 10. Dot patterns that represent the positions on the display area 21 are provided on the display area 21, the digital pen 10 is configured to optically read one of the dot patterns corresponding to the one of the positions, each of the pixels 40 includes the plurality of sub pixels 41 of different colors, each of the dot patterns is formed by a group of the dots 33, and the half or more (more specifically, substantially all) of the dots 33 are provided in the red sub pixels 41r.

In other words, the display device 20 includes the display area 21 in which the plurality of pixels 40 is provided and which displays an image. Dot patterns that are configured to be optically read from the outside and represent the positions on the display area 21 are provided on the display area 21, each of the pixels 40 includes the plurality of sub pixels 41 of different colors, each of the dot patterns is formed by a group of the dots 33, and the half or more (more specifically, substantially all) of the dots 33 are provided in the red sub pixels 41r.

In still other words, the display panel 24 includes the display area 21 in which the plurality of pixels 40 is provided and which displays an image. Dot patterns that are configured to be optically read from the outside and represent the positions on the display area 21 are provided on the display area 21, each of the pixels 40 includes the plurality of sub pixels 41 of different colors, each of the dot patterns is formed by a group of the dots 33, and the half or more (more specifically, substantially all) of the dots 33 are provided in the red sub pixels 41r.

In the above-described configuration, the number of dots 33 provided in the green and blue sub pixels 41g and 41b is small, and therefore, color unevenness in green and blue can be reduced. That is, the dots 33 do not completely transmit visible right. Because of that, even in the sub pixels 41 of the same color, color unevenness between the pixels 41 in which the dots 33 are provided and the pixels 41 in which the dots 33 are not provided occurs. In contrast, in the above-described configuration, at least the half of the dots 33 are provided in the read sub pixels 41r, and thus, green and blue color unevenness can be reduced.

Specifically, substantially all of the dots 33 are provided in the red sub pixels 41r, and therefore, the number of the dots 33 provided in the green and blue sub pixels 41g and 41b can be substantially made zero, so that color unevenness in green and blue can be reduced. “Substantially all” herein means at least 95% or more (the same shall apply hereafter).

Also, by setting other sub pixels 41 than the green sub pixels 41g as the sub pixels 41 of a specific color in which the half or more of the dots 33 are provided, overall color unevenness in the display area 21 can be reduced. That is, by providing the half or more of the dots 33 in the sub pixels 41 of a specific color, color unevenness is possibly increased in the specific color. If the specific color is green, color unevenness is easily recognized by humans because the luminosity factor of green is high. On the other hand, if the specific color is a color other than green, even when color unevenness occurs in the specific color, the color unevenness is inconspicuous. As a result, color unevenness can be reduced in the entire display area 21.

Furthermore, by setting the red sub pixels 41r as the sub pixels 41 of a specific color in which the half or more of the dots 33 are provided, overall color unevenness in the display area 21 can be further reduced. That is, because the luminosity factor of red is the lowest among the three colors, even when color unevenness occurs in red, the color unevenness is inconspicuous to human eyes.

Also, according to the present embodiment, the display control system 100 includes the display device 20 having the display area 21 in which the plurality of pixels 40 is provided and which displays an image, and the digital pen 10 configured to indicate a position on the display area 21, and performs display control in accordance with the position indicated by the digital pen 10. Dot patterns that represent the positions on the display area 21 are provided on the display area 21, the digital pen 10 is configured to optically read one of the dot patterns corresponding to the indicated position, each of the pixels 40 includes the plurality of sub pixels 41 of different colors, each of the dot patterns is formed by a group of the dots 33 provided in the sub pixels 41, and the number of the dots 33 provided in the sub pixels 41, i.e., the green sub pixels 41g, of a color having the highest luminosity factor is the smallest among the sub pixels 41 of the different colors. Specifically, the number of the dots 33 provided in the green sub pixels 41g is substantially zero.

In other words, the display device 20 includes the display area 21 in which the plurality of pixels 40 is provided and which displays an image. Dot patterns that are configured to be optically read from the outside and represent the positions on the display area 21 are provided on the display area 21, each of the pixels 40 includes the plurality of sub pixels 41 of different colors, each of the dot patterns is formed by a group of the dots 33, and the number of the dots 33 provided in the sub pixels 41, i.e., the green sub pixels 41g, of a color having the highest luminosity factor is the smallest among the sub pixels 41 of the different colors. Specifically, the number of the dots 33 provided in the green sub pixels 41g is substantially zero.

In still other words, the display panel 24 includes the display area 21 in which the plurality of pixels 40 is provided and which displays an image. Dot patterns that are configured to be optically read from the outside and represent the position on the display area 21 are provided on the display area 21, each of the pixels 40 includes the plurality of sub pixels 41 of different colors, each of the dot patterns is formed by a group of the dots 33, and the number of the dots 33 provided in the sub pixels 41, i.e., the green sub pixels 41g, of a color having the highest luminosity factor is the smallest among the sub pixels 41 of the different colors. Specifically, the number of the dots 33 provided in the green sub pixels 41g is substantially zero.

The above-described configuration can make brightness unevenness in the entire display area 21 inconspicuous. That is, the dots 33 do not completely transit visible light, and therefore, the brightness unevenness occurs between the sub pixels 41 in which the dots 33 are provided and the sub pixels 41 in which the dots 33 are not provided. In this case, because the luminosity factor of green is the highest among the three colors, if brightness unevenness occurs in green, the brightness unevenness is conspicuous. In contrast, in the above-described configuration, the number of the dots 33 provided in the green sub pixels 41g is the smallest, and thus, brightness unevenness in green can be reduced. As a result, brightness unevenness in the entire display area 21 can be made inconspicuous.

Furthermore, the dots 33 are not provided in the green sub pixels 41g of green having the highest luminosity factor but are provided in the sub pixels 41 of a color other than green, i.e., specifically, the red sub pixels 41r.

In the above-described configuration, the dots 33 are not provided in the green sub pixels 41g of green having the highest luminosity factor of the three different colors, and therefore, brightness unevenness in green can be further reduced. As a result, brightness unevenness in the entire display area 21 can be made inconspicuous furthermore.

Also, according to the present embodiment, the display control system 100 includes the display area 21 in which the plurality of pixels 40 is provided and which displays an image, and the digital pen 10 configured to indicate a position on the display area 21, and performs display control in accordance with the position indicated by the digital pen 10. Dot patterns that represent the positions on the display area 21 are provided on the display area 21, the digital pen 10 is configured to optically read one of the dot patterns corresponding to the indicated position, each of the pixels 40 includes the plurality of sub pixels 41 of different colors, each of the dot patterns is formed by a group of the dots 33 provided in the sub pixels 41, and the number of the dots 33 provided in the sub pixels 41, i.e., the red sub pixels 41r, of a color having the lowest luminosity factor is the largest among the sub pixels 41 of the different colors. Specifically, substantially all of the dots 33 are provided in the red sub pixels 41r.

In other words, the display device 20 includes the display area 21 in which the plurality of pixels 40 is provided and which displays an image. Dot patterns that are configured to be optically read from the outside and represent the positions on the display area 21 are provided on the display area 21, each of the pixels 40 includes the plurality of sub pixels 41 of different colors, each of the dot patterns is formed by a group of the dots 33 provided in the sub pixels 41, and the number of the dots 33 provided in the sub pixels 41, i.e., the red sub pixels 41r, of a color having the lowest luminosity factor is the largest among the sub pixels 41 of the different colors. Specifically, substantially all of the dots 33 are provided in the red sub pixels 41r.

In still other words, the display panel 24 includes the display area 21 in which the plurality of pixels 40 is provided and which displays an image. Dot patterns that are configured to be optically read from the outside and represent the position on the display area 21 are provided on the display area 21, each of the pixels 40 includes the plurality of sub pixels 41 of different colors, each of the dot patterns is formed by a group of the dots 33 provided in the sub pixels 41, and the number of the dots 33 provided in the sub pixels 41, i.e., the red sub pixels 41r, of a color having the lowest luminosity factor is the largest among the sub pixels 41 of the different colors. Specifically, substantially all of the dots 33 are provided in the red sub pixels 41r.

The above-described configuration can make brightness unevenness in the entire display area 21 inconspicuous. That is, the number of the dots 33 provided in the red sub pixels 41r is the largest, i.e., specifically, substantially all of the dots 33 is provided in the red sub pixels 41r, and thus, brightness unevenness in green and blue can be reduced. Although brightness unevenness in red occurs, the brightness unevenness is inconspicuous because the luminosity factor of red is the lowest among the three colors. As a result, brightness unevenness in the entire display area 21 can be reduced.

In order to reduce color unevenness and bright unevenness, in view of luminosity factor, it is preferable that the higher the luminosity factor of the color of the sub pixels 41 is, the less the number of the dots provided in the sub pixels 41 becomes. For example, according to the above-described embodiment, the ratio of the dots 33 provided in the sub pixels 41 preferably decreases in the order of the red sub pixel 41r, the blue sub pixel 41b, and the green sub pixel 41g.

Also, according to the above-described embodiment, the position of the digital pen 10 is detected by reading the dot pattern on the display area 21, thereby enabling high definition handwriting input. That is, another possible configuration which enables handwriting input on a display surface of a display device is a configuration in which a sensor, such as an electrostatic capacitance sensor, etc., is built in the display device, a contact point of a stylus on a display surface is detected by the sensor to detect the position of the stylus, and thus, input in accordance with the trace of the stylus is performed. In such a configuration, the degree of definition of handwriting input depends on the accuracy of detection of the position of the stylus, that is, position detection resolution of the sensor. However, the sensor has a certain size, and it is difficult to provide many sensors in the display device. Also, as the number of touch sensors increases, the cost increases. In contrast, according to this embodiment, the degree of definition of the handwriting input depends on the accuracy of the detection of a dot pattern by the digital pen 10. The detection accuracy can be increased in a simple manner by increasing the density of the dot pattern. To what degree the density of the dot pattern can be increased depends on not only the capability of dot pattern production at high density but also the resolution of the digital pen 10 and the capability of dot pattern determination. However, it is easier to produce a dot pattern at high density than to increase the detection resolution of a touch sensor. Also, even when the resolution of the digital pen 10 is not increased to a very high level, a high-density dot pattern can be read sufficiently enough, as compared to the case where the detection resolution of a touch sensor is increased. Therefore, as compared to the configuration in which the position of a pen is detected by a sensor of a display device, high definition handwriting input can be performed by reading the dot pattern on the display area 21 to detect the position of the digital pen 10.

### 7. Modified Examples

Modified examples of the above-described embodiment will be described below.

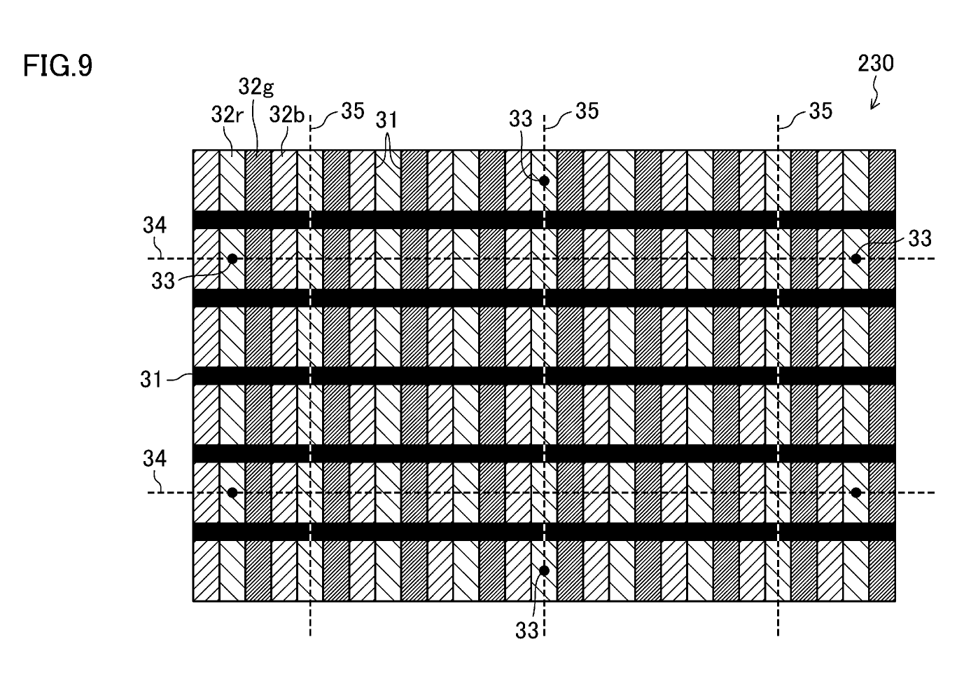

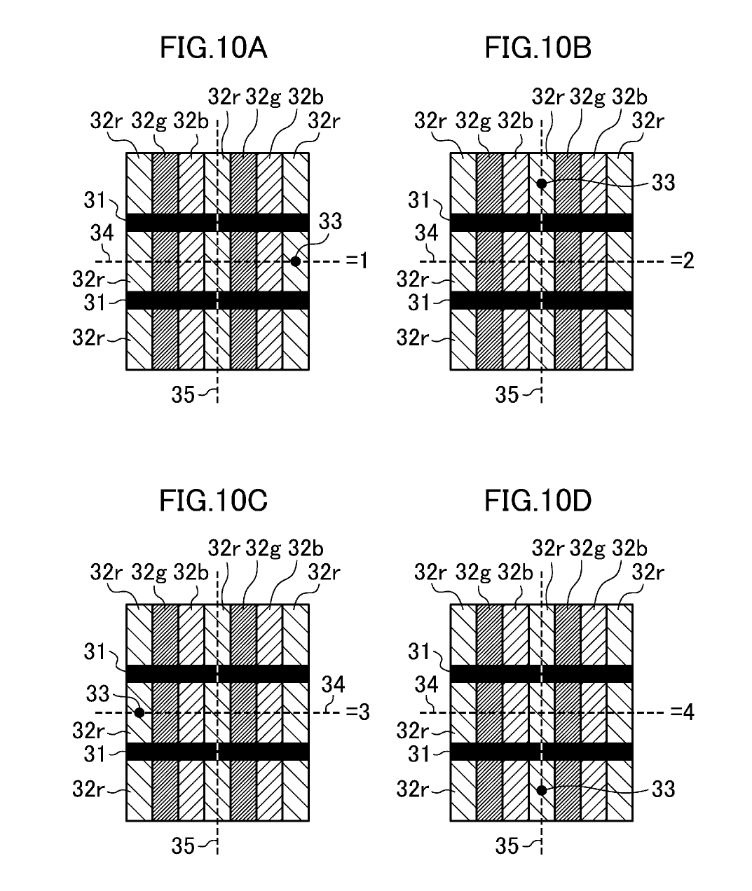

FIG. 9 is a plan view of a color filter 230 according to a modified example. FIGS. 10A-10D are views illustrating position patterns of the dots 33. In the above-described embodiment, each of the dots 33 is shifted from the intersection point of the corresponding one of the first reference lines 34 and the corresponding one of the second reference lines 35 in an oblique direction relative to the first reference line 34 and the second reference line 35. However, as illustrated in FIG. 9, the dot 33 may be located in a position shifted from the intersection point of the first reference line 34 and the second reference line 35 in a direction extending along the first reference line 34 or the second reference line 35. Note that, specifically, similar to the above-described embodiment, each of the dots 33 is provided in the corresponding one of the pixel regions 32 of the color filter 30.

Specifically, in the present modified example, each of the first reference lines 34 is located at the center of each corresponding one of the pixel regions 32 in the longitudinal direction of the pixel region 32. The first reference lines are arranged at every three pixel regions 32 in the longitudinal direction of the pixel regions 32. Each of the second reference lines 35 is located at the center of each corresponding one of the red pixel regions 32r in the lateral direction of the red pixel region 32r. The second reference lines 35 are located in parallel at every three red regions 32r in the lateral direction of the pixel regions 32. As a result, the intersection point of each of the first reference lines 34 and the corresponding one of the second reference lines 35 is located in the corresponding one of the red pixel regions 32r.

The dot 33 is located in a position shifted from the intersection point in any one of four oblique directions extending along the first reference line 34 or the second reference line 35. Specifically, the position of the dot 33 is any of the positions illustrated in FIGS. 10A-10D. In the position of FIG. 10A, the dot 33 is located in a position shifted from the intersection point of the first reference line 34 and the second reference line 35 to the right on the first reference line 34. In this case, the dot 33 is located on the red pixel region 32r located on the right of the red pixel region 32r in which the intersection point is located. In the position of FIG. 10B, the dot 33 is located in a position shifted from the intersection point of the first reference line 34 and the second reference line 35 upward on the second reference line 35. In this case, the dot 33 is located on the red pixel region 32r located above the red pixel region 32r in which the intersection point is located. In the position of FIG. 10C, the dot 33 is located in a position shifted from the intersection point of the first reference line 34 and the second reference line 35 to the left on the first reference line 34. In this case, the dot 33 is located on the red pixel region 32r located on the left of the red pixel region 32r in which the intersection point is located. In the position of FIG. 10D, the dot 33 is located in a position shifted from the intersection point of the first reference line 34 and the second reference line 35 downward on the second reference line 35. In this case, the dot 33 is located on the red pixel region 32r located blow the red pixel region 32r in which the intersection point is located. In the positions according to the present modified example, all of the dots 33 are located in the corresponding red pixel regions 32r, i.e., the red sub pixels 41r.

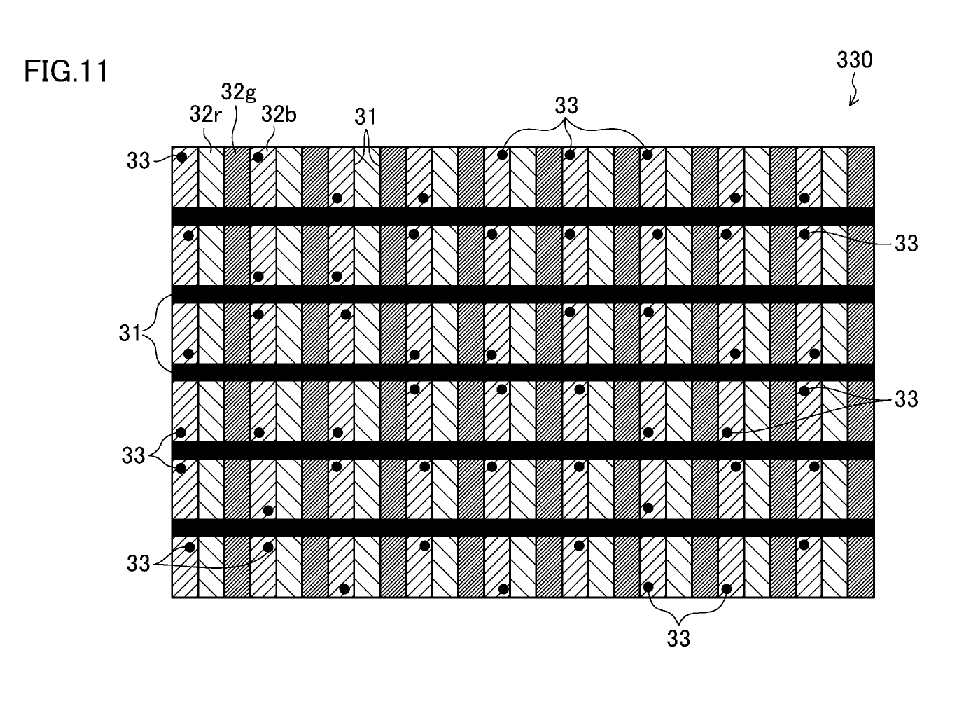

FIG. 11 is an enlarged view of a color filter 330 according to another modified example. In the above-described embodiment, the dots 33 are provided in not all but only some of the red pixel regions 32r. However, as illustrated in FIG. 11, substantially all of the dots 33 are provided in the red pixel regions 32r, and also, the dots 33 may be provided in substantially all of the red pixel regions 32r. Note that, specifically, similar to the above-described embodiment, the dots 33 are provided in the pixel regions 32 of the color filter 30.

In this case, the position of the dot 33 (for example, the upper right corner, the upper left corner, the lower left corner, and the lower right corner) in the red pixel region 32r can represent the position pattern (“1”-“4”). As a result, similar to the above-described embodiment, a dot pattern of 6×6 dots can be formed.

Note that the position pattern of the dots 33 is not limited to the above-described position patterns. Any method may be employed for coding of the dot patterns, and the position pattern of the dots 33 may be changed in accordance with a coding method which is employed. For example, depending on the employed coding method, each dot 33 may be located in any of upper, central, and lower parts in the corresponding one of the red pixel regions 32r in the longitudinal direction thereof.

According to the present modified example, the dots 33 are provided in the sub pixels 41 of a specific color, i.e., specifically, in all of the red sub pixel 41r. In this configuration, for red, there are only the red sub pixels 41r in which the dots 33 are provided but there is no red sub pixel 41r in which the dot 33 is not provided. Thus, color unevenness in red can be reduced.

Also, in the above-described embodiment and the above-described modified examples, substantially all of the dots 33 are provided in the red pixel regions 32r, i.e., the red sub pixels 41r. However, substantially all of the dots 33 may be provided in the sub pixels 41 of a specific color other than red. For example, substantially all of the dots 33 may be provided in the blue sub pixels 41b. As another option, substantially all of the dots 33 may be provided in the green sub pixels 41g. However, in order not to influence an image displayed in the display area 21, it is preferable that substantially all of the dots 33 are provided in the sub pixels 41 of a color other than green, i.e., the red sub pixels 41r or the blue sub pixels 41b, because green has the highest luminosity factor among red, blue, and green. Furthermore, the luminosity factor of red is the lowest among red, blue, and green, and therefore, it is more preferable that substantially all of the dots 33 are provided in the red sub pixels 41r.

### Second Embodiment

Subsequently, a display control system according to a second embodiment will be described. The display control system according to the second embodiment is different from the display control system 100 according to the first embodiment in the positions of dots 33. Each part having a similar configuration to that of the corresponding part in the first embodiment is identified by the same reference character, and the following description is given with focus on parts different from the first embodiment.

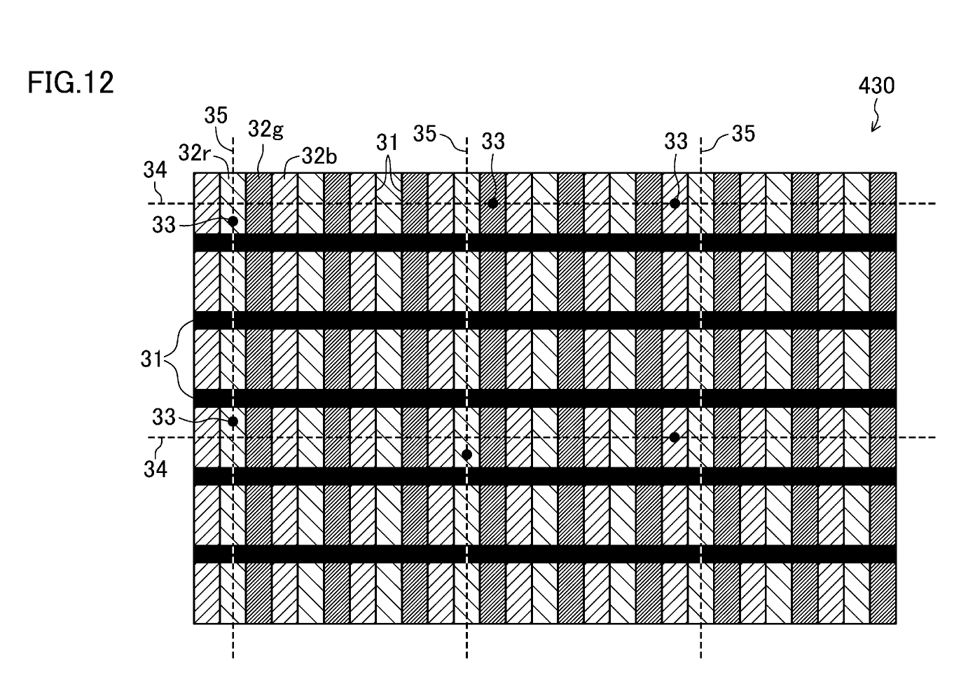

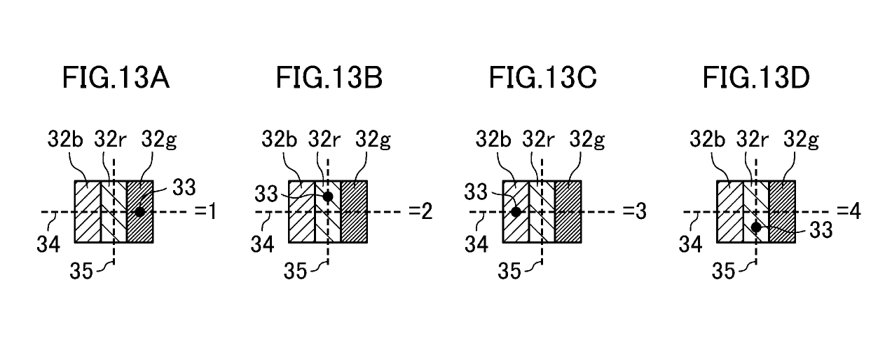

FIG. 12 is a plan view of a color filter 430 according to the second embodiment, and FIGS. 13A-13D are views illustrating position patterns of dots 33. In the display control system according to the second embodiment, the dots 33 are formed in the color filter 430, and thereby, the dots 33 are provided in the sub pixels 41 of the display area 21.

The color filter 430 includes a lattice-shaped black matrix 31, a plurality of pixel regions 32, and a plurality of dots 33.

Similar to the modified example illustrated in FIG. 9 and FIGS. 10A-10D, first and second reference lines 34 and 35 are defined on the pixel regions 32. Specifically, each of the first reference lines 34 is located at the center of each corresponding one of the pixel regions 32 in the longitudinal direction of the pixel region 32. The first reference lines 34 are arranged at every three pixel regions 32 in the longitudinal direction of the pixel regions 32. Each of the second reference lines 35 is located at the center of each corresponding one of the red pixel regions 32r in the lateral direction of the red pixel region 32r. The second reference lines 35 are arranged at every three red regions 32r in the lateral direction of the pixel regions 32. As a result, the intersection point of each of the first reference lines 34 and the corresponding one of the second reference lines 35 is located in the corresponding one of the red pixel regions 32r.

The dot 33 is located in a position shifted from the intersection point in any one of four oblique directions extending along the first reference line 34 or the second reference line 35. Specifically, the position of the dot 33 is any of the positions illustrated in FIGS. 13A-13D. In the position of FIG. 13A, the dot 33 is located in a position shifted from the intersection point of the first reference line 34 and the second reference line 35 to the right on the first reference line 34. In this case, the dot 33 is located in the green pixel region 32g located adjacently on the right of the red pixel region 32r in which the intersection point is located. In the position of FIG. 13B, the dot 33 is located in a position shifted from the intersection point of the first reference line 34 and the second reference line 35 upward on the second reference line 35. In this case, the dot 33 is located in an upper part in the red pixel region 32r in which the intersection point is located. In the position of FIG. 13C, the dot 33 is located in a position shifted from the intersection point of the first reference line 34 and the second reference line 35 to the left on the first reference line 34. In this case, the dot 33 is located in the blue pixel region 32b located adjacently on the left of the red pixel region 32r in which the intersection point is located. In the position of FIG. 13D, the dot 33 is located in a position shifted from the intersection point of the first reference line 34 and the second reference line 35 downward on the second reference line 35. In this case, the dot 33 is located in a lower part in the red pixel region 32r in which the intersection point is located. That is, in two of the four position patterns, the dot 33 is located in the red pixel region 32r, in one of the four position patterns, the dot 33 is located in the blue pixel region 32b, and in one of the four position patterns, the dot 33 is located in the green pixel region 32g.

In a configuration in which a plurality of dot patters is formed in the display area 21 by combining the dots 33 of the four position patterns, assuming that the use frequencies of the four position patterns are approximately the same, the ratio of the dots 33 located in the red pixel regions 32r, the dots 33 located in the blue pixel regions 32b, and the dots 33 of the green pixel regions 32g is approximately 2:1:1.

That is, among the sub pixels 41 of red, green, and blue, the number of the dots 33 provided in the green sub pixels 41g of green having the highest luminosity factor is the smallest. Note that the number of the dots 33 provided in the blue sub pixels 41b is also the smallest. In this configuration, brightness unevenness can be made inconspicuous. That is, the dots 33 do not completely transmit visible light but more or less absorb visible light. Therefore, the brightness is reduced in the sub pixels 41 in which the dots 33 are provided, as compared to the sub pixels 41 in which the dots 33 are provided. As a result, when, for a specific color, there are the sub pixels 41 in which the dots 33 are provided and the sub pixels 41 in which the dots 33 are not provided in a mixed manner, bright unevenness occurs. If the brightness unevenness occurs in a color having a high luminosity factor, the bright unevenness can be easily recognized by human eyes. In the above-described configuration, the number of the dots 33 provided in the green sub pixel 41g of green having the highest luminosity factor among red, green, and blue is the smallest, and therefore, brightness unevenness in green can be reduced as much as possible. As a result, brightness unevenness can be made inconspicuous.

From another viewpoint, among the sub pixels 41 of red, green, and blue, the number of the dots 33 provided in the red sub pixels 41r of red having the lowest luminosity factor is the largest. This configuration can make brightness unevenness inconspicuous. That is, even when brightness unevenness occurs in red, the brightness unevenness is not easily recognized by human eyes, because the luminosity factor is the lowest in red among red, green, and blue. In the above-described configuration, brightness unevenness in blue and green which have a higher luminosity factor than that of red can be reduced as much as possible by increasing the number of the dots 33 provided in the red sub pixels 41r. As a result, brightness of unevenness can be made inconspicuous.

From still another viewpoint, the half or more of the dots 33 are provided in the sub pixels 41, i.e., the red sub pixels 41r, of a specific color. Thus, color unevenness of red can be reduced. That is, the number of the dots 33 provided in each of the green sub pixels 41g and the blue sub pixels 41b can be reduced as much as possible. As a result, for green, the number of the green sub pixels 41g in which the dots 33 are provided is smaller than the number of the green sub pixels 41g in which the dots 33 are not provided, and therefore, color unevenness of green can be reduced. Similarly, for blue, the number of the blue sub pixels 41b in which the dots 33 are provided is smaller than the number of the blue sub pixels 41b in which the dots 33 are not provided, and therefore, color unevenness of blue can be reduced.

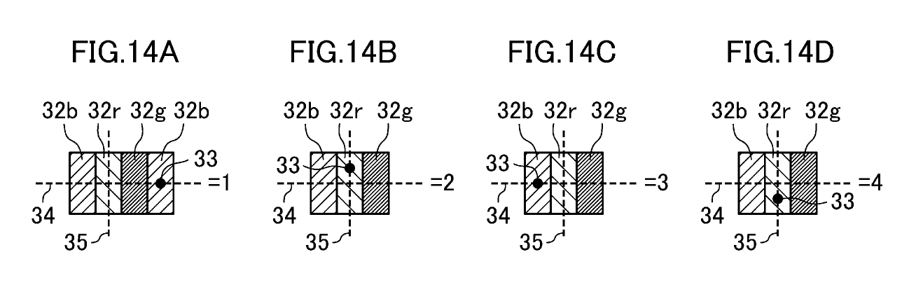

Note that, in view of reducing brightness unevenness, it is preferable that the dots 33 are not provided in the green sub pixels 41g of green having the highest luminosity factor but are provided in the sub pixels 41, i.e., the red sub pixels 41r and/or the blue sub pixels 41b, of a color or colors other than green. FIGS. 14A-14D are views illustrating position patterns of dots in a configuration in which the dots 33 are not provided in the green sub pixels 41g but are provided in the sub pixels 41 of a color other than green. In the position patterns, the first and second reference lines 34 and 35 are defined in a similar manner to that in the modified example illustrated in FIG. 12. Of the four position patterns, positions 2-4 illustrated in FIGS. 14B-14D are the same as the position patterns illustrated in FIGS. 13B-13D, and the dots 33 are provided in the sub pixels 41 of colors other than green. On the other hand, in a position pattern “1” illustrated in FIG. 14A, the dot 33 is located in the blue pixel region 32b located in a position which is shifted from the intersection point of the first reference line 34 and the second reference line 35 to right and is located further on the right of the green pixel region 32g located on the right of the red pixel region 32r in which the intersection point is located. That is, of the position patterns illustrated in FIGS. 14A-14D, in two position patterns, the dot 33 is located in the red pixel region 32r, and in two position patterns, the dot 33 is located in the blue pixel region 32b. In the above-described configuration, the dots 33 are not provided in the green sub pixels 41g of green having the highest luminosity factor among the three colors, and thus, brightness unevenness can be made inconspicuous.

### OTHER EMBODIMENTS

As described above, embodiments have been described as examples of the technology disclosed in the present application. However, the technology according to the present disclosure is not limited thereto but is applicable to embodiments with appropriate modification, replacement, addition, and omission, etc. Moreover, it is also possible to form a new embodiment by combining constituent elements described in the above first and second embodiments.

For the above-described embodiments, the following configuration may be employed.

In each of the above-described embodiments, a liquid crystal display has been described as an example of the display device, but the display device is not limited thereto. The display device 20 may be a device, such as a plasma display, an organic EL display, or an inorganic EL display, etc., which can display a character and an image. Also, the display device 20 may be a device, such as an electronic paper, a display surface of which can be freely deformed.

The display device 20 may be a notebook PC or a display of a mobile tablet. Furthermore, the display device 20 may be a TV or an electronic black board, etc.

The digital pen 10 or the display device 20 may include a switching section configured to switch processing that is to be performed in response to input of the position information made using the digital pen 10 from one to another. Specifically, a switch may be provided in the digital pen 10 to switch the processing from one to another among input of a character, etc., erasing of a character, etc., moving of a cursor, and selecting of an icon, etc. As another option, the display device 20 may be configured to display icons used for switching the processing from one to another among input of a character, etc., erasing of a character, etc., moving of a cursor, and selecting of an icon, etc., in order for a user to select one of the icons using the digital pen 10. Furthermore, a switch corresponding to a right click or a left click of a mouse may be provided to the digital pen 10 or the display device 20. Thus, operability can be further increased.

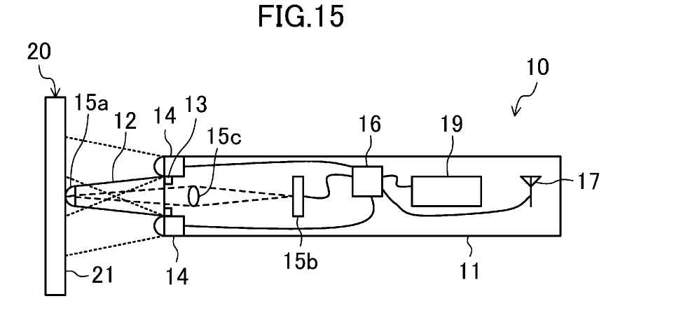

Also, the above-described configurations of the digital pen 10 and the display device 20 are merely examples, and the configurations of the digital pen 10 and the display device 20 are not limited thereto. FIG. 15 is a schematic cross-sectional view of the digital pen 10 according to another embodiment. For example, in the digital pen 10 illustrated in FIG. 15, the nib 12 is made of a material which is transmissive to infrared light. The objective lens 15a is built in the tip of the nib 12. The reader 15 further includes a lens 15c. The objective lens 15a and the lens 15c form an optical system. A plurality of optical source 14 (for example, four optical sources 14) is located at the tip of the body 11 so as to surround the nib 12. The number of the optical sources 14 can be set, as appropriate. Also, the optical source 14 may be formed into a ring shape. In this configuration, the contact point of the digital pen 10 and the display area 21 corresponds to a part in which a dot pattern is read, and thus, the position of the tip of the nib 12 can be more accurately detected. As a result, a user can realize handwriting using the digital pen 10 such that the user has a feeling close to that of actually writing using a pen.

Transmission and reception of a signal between the digital pen 10 and the display device 20 are performed via wireless communication, but are not limited thereto. The digital pen 10 may be connected to the display device 20 via a wire so that transmission and reception of a signal is performed via the wire.

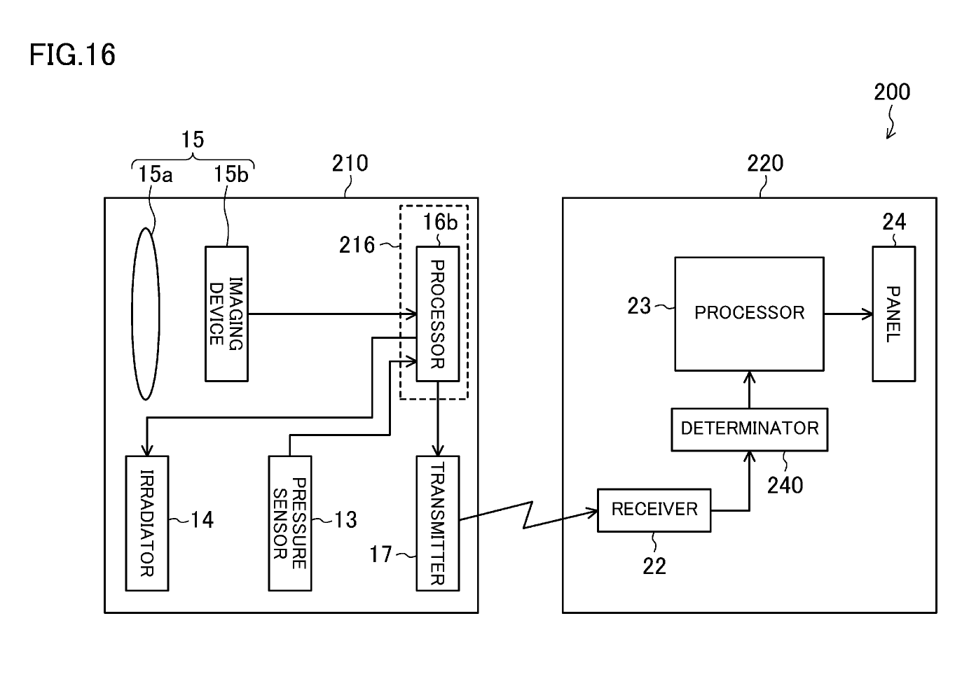

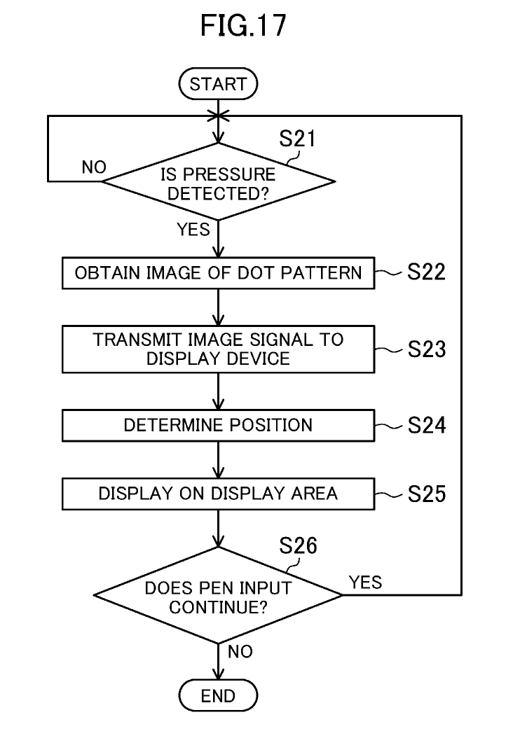

Also, in the first embodiment, the digital pen 10 performs the processing up to determination of the position information and transmits the position information to the display device 20, but the processing performed in a display control system according to the present disclosure is not limited thereto. FIG. 16 is a block diagram of a display control system 200 according to another embodiment. A digital pen 210 illustrated in FIG. 16 includes the pressure sensor 13, the optical source 14, the reader 15, the controller 216, and the transmitter 17. The configurations of pressure sensor 13, the optical source 14, the reader 15, and the transmitter 17 are similar to those of the above-described embodiments. The controller 216 includes the pen processor 16b but does not include the decoder 16a of the first embodiment. That is, the controller 216 outputs an image signal input from the imaging device 15b to the transmitter 17 without determining the position information of the digital pen 210 based on the image signal. An image signal captured by the imaging device 15b is thus transmitted from the digital pen 210. A display device 220 illustrated in FIG. 16 includes the receiver 22 configured to receive a signal from the outside, the display processor 23 configured to control the entire display device 220, the display panel 24 configured to display an image, and a decoder 240 configured to determine the position of the digital pen 10. The configurations of the receiver 22, the display processor 23, and the display panel 24 are similar to those of the above-described embodiments. A dot pattern is formed on the display area 21 of the display panel 24. The receiver 22 receives a signal transmitted from the digital pen 210 and transmits the signal to the decoder 240. The decoder 240 has a similar function to that of the decoder 16a of the digital pen 10 in the above-described embodiments. In this configuration, as illustrated in FIG. 17, the digital pen 210 obtains an image of a dot pattern with the imaging device 15b (Step S22), and an image signal thereof is transmitted to the display device 220 from the digital pen 210 (Step S23). Then, the detector 240 of the display device 220 determines the position of the digital pen 210, based on the image signal (Step S24). Other processing is similar to that in the above-described embodiments.

Note that, in the digital pen 210, after an image of a dot pattern is obtained, the processing up to image processing may be performed to reduce the amount of date, and then, a processed signal may be transmitted to the display device 220. That is, as long as the digital pen 10 and 210 obtains information relating to a position indicated by the digital pen 10 and 210 on the display area 21, the information relating to the position is transmitted from the digital pen 10 and 210 to the display device 20 and 220, and the display device 20 and 220 performs various display controls in accordance with the information relating to the position, any information may be used as the information relating to the position.

The decoder configured to determine the position of the digital pen on the display area 21 may be provided as an individual control unit separated from the digital pen 10 and the display device 20. For example, a display control system in which a digital pen is added to a desktop PC including a display device (an example of the display device) and a PC body (an example of the controller) may be configured such that, in the display control system, a dot pattern is provided on a display area of the display device, the digital pen optically reads the dot pattern and transmits the dot pattern to the PC body, the PC body determines the position of the digital pen, based on the dot pattern, and orders the display device to perform processing in accordance with the determined position.

In the above-described embodiments, the pressure sensor 13 is used only to determine whether or not pressure is applied, but determination on whether or not pressure is applied is not limited thereto. For example, the magnitude of pressure may be detected, based on the result of detection by the pressure sensor 13. Thus, continuous changes in pressure can be read. As a result, the width and thickness of a displayed line can be changed, based on the magnitude of pressure.

Note that, in the above-described embodiments, using the pressure sensor 13, whether or not an input is made using the digital pens 10 is detected, but the detection of an input is not limited thereto. A switch configured to switch between on and off of input may be provided to the digital pen 10 so that, when the switch is turned on, it is determined that an input is made. In this case, even when the digital pen 10 does not contact a surface of the display area 21, an input can be made. As another option, the display device 20 may be configured so as to cause a surface of the display area 21 to oscillate at a certain frequency and detect a change in the frequency due to contact of the digital pen 10 with the surface of the display area 21, thereby detecting whether or not an input is made.

In the above-described embodiments, each of the pixel regions 32 has a rectangular shape, but is not limited thereto. The shape of each of the pixel regions 32 may be a triangle or a parallelogram, etc., or a shape obtained by combining those shapes. The shape of each of the pixel regions 32 may be a shape with which the display device can output a character or an image. The black matrix 31 may be changed as appropriate in accordance with the shape of each of the pixel regions 32.

The first and second reference lines 34 and 35 used for arranging the dots 33 are not limited to the above-described embodiments. For example, the first reference lines 34 may be defined on the black matrix 31 or may be defined on the pixel regions 32. Furthermore, on which color pixel regions 32 the first reference lines 34 are defined may be arbitrarily selected. The same applies to the second reference lines 35.

In the above-described embodiments, a dot pattern is formed in a unit area of 6×6 dots, but is not limited thereto. The number of dots forming a unit area can be set as appropriate in accordance with the designs of the digital pen 10 and the display device 20. The configuration of a dot pattern is not limited to a combination of positions of dots included in a predetermined area. As long as a dot pattern can indicate specific position information, a method of coding is not limited to the above-described embodiments.

In the above-described embodiments, the position information pattern is made of dots, but is not limited to a dot. Instead of dots, the position information pattern may be formed by marks represented by a diagram, such as a triangle and a quadrangle, etc., a character, such as an alphabet, etc. For example, a mark may be formed by filling the entire part of a pixel region 32.

The dots 33 are provided in the color filter 30, but are not limited thereto. The dots 33 may be provided in the glass substrates 25 or the polarizing filter 26, as long as the dots 33 are provided in positions corresponding to the sub pixels 41. Furthermore, the display panel 24 may have a configuration including another sheet separated from the color filter 30, the glass substrates 25, and the polarizing filter 26. As another option, the dots 33 can be represented by the pixels 40 of the display panel 24. That is, a configuration in which the dots 33 are provided in the display area 21 by controlling display of one of the pixels 40 or one of the sub pixels 41 in a position corresponding to any of “1”-“4” may be realized.

The decoder 16a converts a dot pattern to a position coordinate by operation, but is not limited thereto. For example, the decoder 16a may be configured to store all of dot patterns and position coordinates linked to the dot patterns, check an obtained dot pattern with relationships between the stored dot patterns and position coordinates, and determine a corresponding position coordinate.

As presented above, the embodiments have been described as examples of the technology according to the present disclosure. For this purpose, the accompanying drawings and the detailed description are provided.

Therefore, components illustrated in the accompanying drawings and mentioned in the detailed description may include not only components essential for solving problems, but also components that are provided to illustrate the above-described technology and are not essential for solving problems. Therefore, such inessential components should not be readily construed as being essential based on the fact that such inessential components are shown in the accompanying drawings or mentioned in the detailed description.

Furthermore, the above-described embodiments have been described to exemplify the technology according to the present disclosure, and therefore, various modifications, replacements, additions, and omissions may be made within the scope of the claims and the scope of the equivalents thereof.

As described above, the technology disclosed herein is useful for a display panel, a display device, and a display control system.

What is claimed is:

1. A display control system, comprising:
a display device including a display area in which a plurality of pixels is provided and which displays an image; and
a pointing device configured to indicate one of positions on the display area,
wherein
the display control system performs display control in accordance with the one of the positions indicated by the pointing device,
position information patterns that represent the positions on the display area are provided in the display area,
the pointing device is configured to optically read one of the position information patterns corresponding to the one of the positions,
each of the pixels includes sub pixels of a plurality of different colors,
each of the position information patterns is formed by a group of a plurality of marks, and
the half or more of the marks are provided in the sub pixels of a specific color of the plurality of different colors.

2. The display control system of claim 1, wherein
all of the marks is provided in the sub pixels of a specific color.

3. The display control system of claim 1, wherein
the specific color is a color other than a color having the highest luminosity factor among the plurality of different colors.

4. The display control system of claim 1, wherein
the marks are provided in all of the sub pixels of the specific colors.

5. The display control system of claim 1, wherein
each of the position information patterns is formed by a group of a plurality of marks provided in the sub pixels, and
the number of the marks provided in the sub pixels of a color having the highest luminosity factor is the smallest among the sub pixels of the different colors.

6. The display control system of claim 1, wherein
each of the position information patterns is formed by a group of a plurality of marks provided in the sub pixels, and
the number of the marks provided in the sub pixels of a color having the lowest luminosity factor is the largest among the sub pixels of the different colors.

7. The display control system of claim 6, wherein
the marks are not provided in the sub pixels of a color having the highest luminosity factor but are provided in the sub pixels of a color other than the color having the highest luminosity factor.

8. A display device, comprising:
a display area in which a plurality of pixels is provided and which displays an image,
position information patterns that are configured to be optically read from outside and represent the positions on the display area are provided in the display area,
each of the pixels includes sub pixels of a plurality of different colors,
each of the position information patterns is formed by a group of a plurality of marks, and
the half or more of the marks are provided in the sub pixels of a specific color of the plurality of different colors.

9. The display device of claim 8, wherein
all of the marks is provided in the sub pixels of a specific color.

10. The display device of claim 8, wherein
the specific color is a color other than a color having the highest luminosity factor among the plurality of different colors.

11. The displace device of claim 8, wherein
the marks are provided in all of the sub pixels of the specific colors.

12. The display device of claim 8, wherein
each of the position information patterns is formed by a group of a plurality of marks provided in the sub pixels, and
the number of the marks provided in the sub pixels of a color having the highest luminosity factor is the smallest among the sub pixels of the different colors.

13. The display device of claim 8, wherein
each of the position information patterns is formed by a group of a plurality of marks provided in the sub pixels, and
the number of the marks provided in the sub pixels of a color having the lowest luminosity factor is the largest among the sub pixels of the different colors.

14. The display device of claim 13, wherein
the marks are not provided in the sub pixels of a color having the highest luminosity factor but are provided in the sub pixels of a color other than the color having the highest luminosity factor.
